(19) United States
(12) Patent Application Publication
(10) Pub. No.: US 2012/0290793 A1
(43) Pub. Date: Nov. 15, 2012

(54) EFFICIENT TAG STORAGE FOR LARGE DATA CACHES

(76) Inventors: Jaewoong Chung, Bellevue, WA (US); Niranjan Soundararajan, Hillsboro, OR (US)

(21) Appl. No.: 13/104,865

(22) Filed: May 10, 2011

(51) Int. Cl. G06F 12/08

(52) U.S. Cl. 711/119; 711/E12.017

(57) ABSTRACT

An apparatus, method, and medium are disclosed for implementing data caching in a computer system. The apparatus comprises a first data cache, a second data cache, and cache logic. The cache logic is configured to cache memory data in the first data cache. Caching the memory data in the first data cache comprises storing the memory data in the first data cache and storing in the second data cache, but not in the first data cache, tag data corresponding to the memory data.

### BACKGROUND

A central difficulty of building more powerful computer processors is the wide disparity between the speed at which processing cores can perform computations and the speed at which they can retrieve data from memory on which to perform those computations. Although much effort has been directed at addressing the “memory gap,” processing capability has continued to outpace memory speeds in recent years. Moreover, as today's computer processors become increasingly multi-core (i.e., include multiple computing units, each configured to execute respective streams of software instructions) the demands on memory bandwidth continue to grow.

One reason why access to memory (e.g., to off-chip dynamic random access memory) has been insufficient to meet the growing throughput demands of multi-core processors is the limited scalability of I/O pins. Stacked memory, or 3D stacking, is a recent proposal that addresses this limitation by stacking memory directly on top of a processor, thereby significantly reducing wire delays between the processor and memory. For example, stacked-memory circuits can be constructed using multiple layers of active silicon bonded with dense, low-latency, high-bandwidth vertical interconnects. Compared to traditional, off-chip DRAM, stacked memory offers increased data bandwidth, decreased latency, and lower energy requirements. Memory stacking also enables computer architects to merge dissimilar memory technologies, such as high-speed CMOS (complementary metal-oxide-semiconductor), high-density DRAM, eDRAM, and/or others.

Stacked-memory technology has been used to implement large, last-level data caches (i.e., lowest level of the cache hierarchy), such as L4 caches. Large, last-level caches may be desirable for accommodating the sizeable memory footprints of modern applications and/or the high memory demands of multi-core processors.

Implementing large, last-level caches using stacked memory (i.e., stacked-memory caches) presents several advantages. For example, such caches may be managed by hardware rather than by software, which may allow the cache to easily adapt to application phase changes and avoid translation lookaside buffer (TLB) flushes associated with data movement on and off-chip. Furthermore, because traditional caches are implemented using fast but expensive static memory that consumes die space inefficiently (e.g., SRAM), they are expensive to produce, have a small capacity, and are configured in fixed configurations (e.g., associativity, block size, etc.). In contrast, stacked-memory caches may be implemented using dynamic memory (e.g., DRAM), which is less expensive and denser than the static memory used to build traditional caches. Accordingly, a stacked-memory cache may provide a large, last-level cache at a lower cost than can traditional SRAM-based techniques.

### SUMMARY OF EMBODIMENTS

An apparatus, method, and medium are disclosed for implementing data caching in a computer system. The apparatus comprises a first data cache, a second data cache, and cache logic. The cache logic is configured to cache memory data in the first data cache. Caching the memory data in the first data cache comprises storing the memory data in the first data cache and storing in the second data cache, but not in the first data cache, tag data corresponding to the memory data.

In some embodiments, the first data cache may be dynamically reconfigurable at runtime. For example, software (e.g., an operating system) may modify the size, block size, number of blocks, associativity level, and/or other parameters of the first data cache by modifying one or more configuration registers of the first data cache and/or of the second data cache. In some embodiments, the software may reconfigure the first data cache in response to detecting particular characteristics of a workload executing on one or more processors.

In various embodiments, the first and second data caches may implement respective levels of a data cache hierarchy. For example, the first data cache may implement a level of the cache hierarchy that is immediately below the level implemented by the second data cache (e.g., first data cache implements an L4 and the second data cache implements an L3 cache). In some embodiments, the first data cache may be a large, last level cache, which may be implemented using stacked memory.

### BRIEF DESCRIPTION OF THE DRAWINGS

FIG. 1 is a block diagram illustrating various components of a processor that includes a reconfigurable L4 data cache with L3-implemented tag array, according to some embodiments.

FIG. 2 is a block diagram illustrating the fields into which a given cache may decompose a given memory address, according to some embodiments.

FIG. 3a is a block diagram illustrating how some L3 cache blocks may be reserved for storing L4 tags, according to various embodiments.

FIG. 3b illustrates a tag structure usable to store cache tags, according to some embodiments.

FIG. 4a illustrates various registers that an L3 cache logic may include for implementing a reconfigurable L4 cache, according to some embodiments.

FIG. 4b illustrates various registers that an L4 cache logic may include for implementing a reconfigurable L4 cache, according to some embodiments.

FIG. 5 is a flow diagram illustrating a method for consulting L4 tags stored in an L3 cache to determine whether the L4 cache stores data corresponding to a given memory address, according to some embodiments.

FIG. 6 illustrates an example arrangement of cache blocks on DRAM pages, wherein each page stores physically contiguous memory.

FIG. 7 is a flow diagram illustrating a method for locating the L4 cache block that corresponds to a given physical address, according to some embodiments.

FIG. 8 is a flow diagram of a method for reconfiguring an L4 cache during runtime, according to some embodiments.

FIG. 9 is a table illustrating four example configurations for configuration registers of a reconfigurable cache implementation, according to some embodiments.

FIG. 10 is a block diagram illustrating a computer system configured to utilize a stacked DRAM cache as described herein, according to some embodiments.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

First,” “Second,” etc. As used herein, these terms are used as labels for nouns that they precede, and do not imply any type of ordering (e.g., spatial, temporal, logical, etc.). For example, in a processor having eight processing elements or cores, the terms “first” and “second” processing elements can be used to refer to any two of the eight processing elements. In other words, the “first” and “second” processing elements are not limited to logical processing elements 0 and 1.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

Cache sizes are increasing at a tremendous rate as processors need to support ever-larger memory footprints of applications and multi-programming levels increase. Stacked memory promises to provide significantly large die area, which can be used to implement large, last-level DRAM caches that can range in size from hundreds of megabytes to even larger in the future.

One difficulty in building large, stacked DRAM caches is that the size of the tag array needed to support such a cache can consume significant die area. Caches are typically organized into two independent arrays: the data array and the tag array. The data array entries hold memory data from respective memory blocks while the tag array holds identifiers (i.e., tags) that identify those memory blocks. For example, in a set associative cache, a tag may uniquely identify a given memory block from among those that map into a particular set. Implementing such tag arrays can consume significant die space. For example, a typical 256 MB cache with 64 B cache lines could require 11 MB of tag array.

Further compounding the problem, tag arrays often require a share of die area that is disproportionate to their capacity. Because access to the tag array must be fast, such arrays are often built using fast, expensive static RAM (SRAM) or embedded dynamic RAM (eDRAM), even if the data array is implemented using slower, cheaper, and denser dynamic RAM (DRAM). Unfortunately, technologies such as SRAM are significantly less dense than DRAM (often 12-15 times larger), which means that tag arrays require more die space per unit of capacity than does the DRAM-implemented data array. Consequently, the die space required for a tag array is a significant barrier to implementing large stacked DRAM caches.

According to various embodiments, a large stacked-memory cache may be configured to use cache blocks in a lower-level cache to store tag information. For example, in some embodiments, the data array of a large L4 cache may be implemented using stacked DRAM while the tag array for the L4 cache may be implemented using various blocks in an L3 cache of the system.

In some embodiments, the stacked-memory cache may be implemented as a reconfigurable cache. While conventional cache designs are restricted to static configurations (e.g., total size, associativity, block sizes, etc.), a reconfigurable cache, as described herein, may be adaptive and/or responsive to system workload, such that the particular cache configuration is tailored to the workload.

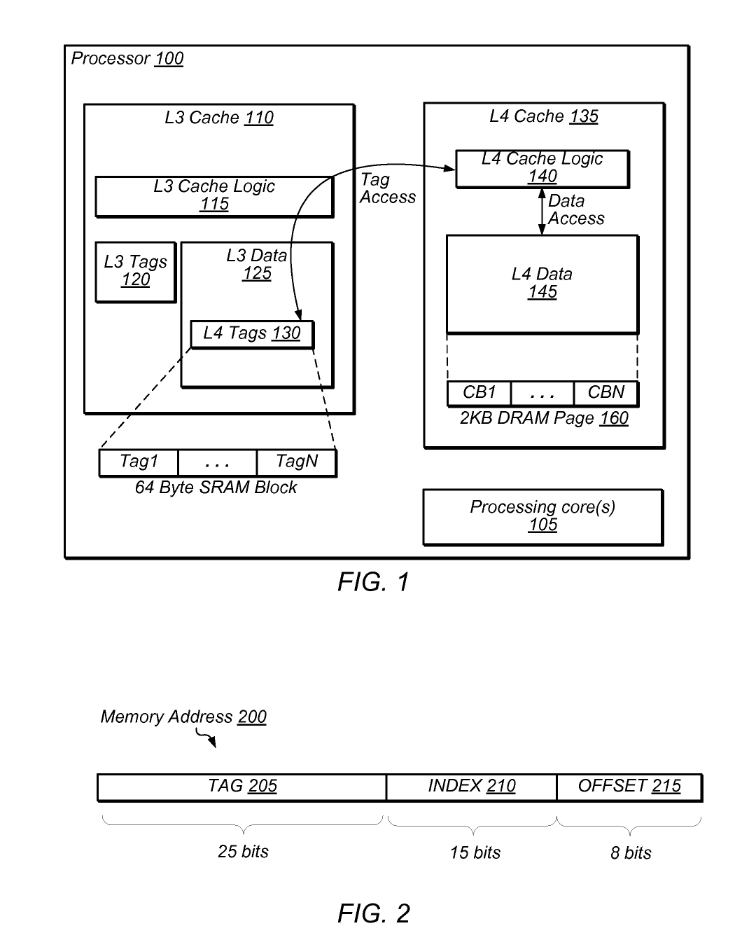

FIG. 1 is a block diagram illustrating various components of a processor that includes a reconfigurable L4 data cache with L3-implemented tag array, according to some embodiments. Many of the embodiments described herein are illustrated in terms of an L4 cache whose tag array is stored in the L3 immediately below the L4 in the cache hierarchy. However, these examples are not intended to limit embodiments to L4 and L3 cache cooperation per se. Rather, in different embodiments, the techniques and systems described herein may be applied to caches at various levels of the cache hierarchy. As used herein, a first cache is said to be at a higher level than (or above) a second cache in a cache hierarchy if the processor attempts to find memory data in the first cache before attempting searching the second cache (e.g., in the event of a cache miss on the first cache).

According to the illustrated embodiment, processor 100 includes L3 cache 110, L4 cache 135, and one or more processing cores 105. Each of processing cores 105 may be configured to execute a respective stream of instructions and various ones of processors 105 may share access to L3 110 and/or L4 135. Processing cores 105 may also include respective private caches (e.g., L1) and/or other shared data caches (e.g., L2).

L3 cache 110 and L4 cache 135 may implement respective levels of a data cache hierarchy on processor 100 (e.g., L3 cache 110 may implement a third-level cache while L4 cache 135 implements a lower, fourth-level cache). According to such a hierarchy, processing core(s) 105 may be configured to search for data in L4 cache 135 if the data is not found in L3 cache 110. In different embodiments, L3 cache 110 and L4 cache 135 may cooperate for caching data from system memory according to different policies and/or protocols.

In some embodiments, L4 cache 135 may be implemented as a stacked-memory cache that uses DRAM to store data. For example, L4 135 includes L4 data array 145, which may be implemented using DRAM. As a running example, we will suppose that L4 is configured as a 256 MB, 32-way, DRAM cache with 256 B cache blocks stored in 2 KB DRAM pages (e.g., 3 KB DRAM page 160), each of which is configured to store multiple cache blocks, such as CB1 through CBN, which may be consecutive in the cache.

L4 cache 135 includes cache logic 140 for managing the cache. Cache logic 140 (and/or cache logic 115) may be implemented in hardware, using hardware circuitry. In some embodiments, cache logic 140 may be configured to determine whether required data exists in the cache, to remove stale data from the cache, and/or to insert new data into the cache. When determining whether data from a particular memory address is stored in the cache, L4 cache logic 140 may decompose the memory address into a number of fields, including a tag, and use those components to determine whether and/or where data corresponding to the memory address exists in the cache.

FIG. 2 is a block diagram illustrating the fields into which a given cache may decompose a given memory address, according to some embodiments. The particular fields and their lengths may vary depending on the memory address (e.g., number of bits, endian-ness, etc.) and/or on the configuration of the cache itself (e.g., degree of associativity, number of blocks, size of blocks, etc.). For example, FIG. 2 is a block diagram illustrating the fields of a 48-bit memory address, as determined by our example L4 cache (i.e., a 256 MB, 32-way cache with 256 B cache blocks). According to the illustrated embodiment, the highest-order 25 bits of the address correspond to tag 205, the next lower-order 15 bits to index 210, and the lowest-order 8 bits to offset 215. In such embodiments, index 210 may be usable to locate the set of cache blocks to which the memory address maps (i.e., if the data corresponding to the memory address is stored within the cache, it is stored at one of the blocks in the set). The cache logic (e.g., 140) may determine respective tags associated with the cache blocks in the set and compare those tags to tag 205. If one of the tags matches tag 205, then the cache line corresponding to that tag stores the data for that memory address. The cache logic may then use offset 215 to determine where that data is stored within the matching cache block.

Returning now to FIG. 1, data for the L4 cache lines may be stored in L4 data 145. As described above, L4 cache 135 may be implemented as a stacked-memory cache that uses DRAM, or another dense memory technology, to store data 145. Thus, L4 data 145 may be configured to have a high memory capacity at relatively low cost. However, because of the high capacity of L4 data 145, implementing a corresponding tag array may require significant die space, particularly if performance concerns dictate that such a tag array should be implemented in SRAM, a relatively sparse memory technology.

According to the illustrated embodiment, rather than implementing the L4 tag array in the L4 itself, L4 135 may be configured to store its tags in a lower-level cache, such as L3 110. For example, in the illustrated embodiment, L3 cache 110 includes L3 cache logic 115 for managing the L3 cache (i.e., analogous to L4 cache logic 140), L3 tag array 120, and L3 data array 125. In addition to storing L3 data, L3 110 may be configured to reserve some number of cache blocks of L3 data 125 for storing tags on behalf of L4 135. For example, in the illustrated embodiment, L4 tags 130 are stored within L3 data 125 and are usable by L4 135. As shown in FIG. 1, each cache block in L3 data 125 may hold multiple L4 tags.

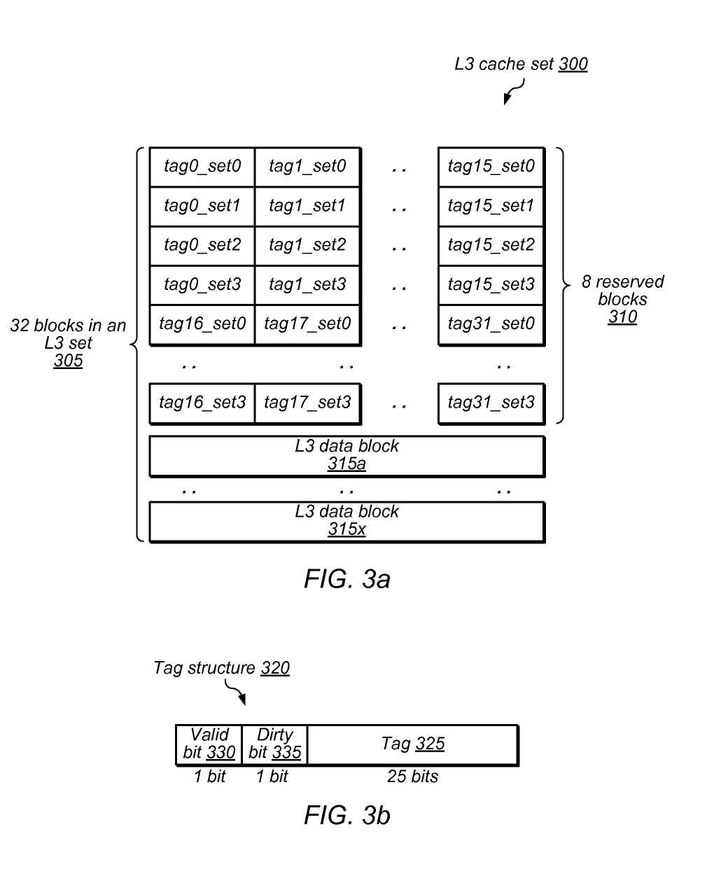

FIG. 3a is a block diagram illustrating how some L3 cache blocks may be reserved for storing L4 tags, according to various embodiments. Cache set 300 includes a number of blocks, some of which (e.g., 315a-315×) are used to store L3 data for the L3 cache. However, other blocks, such as reserved blocks 310, are reserved for storing L4 tags.

The L3 cache may store each L4 tag as a tag structure, such as tag structure 320 of FIG. 3b. The tag structure of FIG. 3b includes the tag itself (i.e., tag 325), as well as tag metadata. In the illustrated example, the tag is 25 bits and the tag metadata includes a valid bit 330 and dirty bit 335. In other embodiments, the tag structure may include other tag metadata.

Suppose for purposes of our running example (256 MB, 32-way, 256 B block, 2 KB DRAM page L4; 28-bit tag structures), that L3 cache 110 is a 16 MB, 32-way cache with 64 B cache lines, and that L3 cache set 300 corresponds to a cache set of L3 110 (i.e., in data 125). Given this example configuration, the total space requirement for L4 tags is 4 MB. Accordingly, each L3 cache set (e.g., 300) may reserve eight of its 32 blocks for storing L4 tag data. For example, cache set 300 includes 32 blocks 305, and reserves 8 of those blocks (310) for storing L4 tags, while the remainder (i.e., 315a-315×) store L3 data as usual. The eight reserved blocks (310) have a total capacity of 512 B, which is sufficient to store 128, 28-bit tag structures. Reserved blocks 310 therefore suffice to store tag data for four, 32-way L4 sets. In the illustrated embodiment, the first block of cache set 300 stores sixteen tags for set0 of the L4, the next block stores sixteen tags for set1, and so forth until set3. The fifth block stores the remaining tags belonging to set0, the sixth block stores the remaining tags belonging to set 1, and so forth, such that the eight reserved blocks 310 store all the tag data for L4 sets 0-3. The technique of allocating each of N consecutive L3 blocks to a different L4 set and then repeating the allocation pattern on the next N consecutive L3 blocks may be referred to herein as striping. The reader should note that the striping configuration of FIG. 3 is intended to be illustrative only and that it should be understood that, in different embodiments, the reserved blocks may store L4 tags in a different order.

Returning to FIG. 1, in some embodiments, L3 cache logic 110 and L4 cache logic 140 may be configured to cooperate in implementing the distributed tag scheme. For example, to access (e.g., read or write) L4 tag data, L4 cache logic 140 may communicate with L3 cache logic 115, which in turn, may fetch the required data (e.g., L4 tags 130) from L3 data 125.

Placing L4 tags in the data array of a lower-level cache, such as L3, may enable multiple benefits. For example, the tag storage scheme described herein may enable the system to (1) make more effective use of die space, and/or (2) reconfigure the L4 cache in response to changing workloads.

Regarding die space, L3 caches are often highly associative, which means that requisitioning some cache blocks may have little impact on the overall performance of the L3. Moreover, the large L4 cache that the scheme makes possible may offset or eliminate any performance loss caused by the effectively smaller L3. Furthermore, the additional die space saved by not implementing a dedicated L4 tag array maybe used to enlarge the L3 cache, such that L3 performance loss is mitigated or eliminated altogether.

Regarding reconfigurability, in some embodiments, L3 logic 115 and L4 logic 140 may be configured with registers that control the L4 cache configuration. During (or before) runtime, the values in these registers may be modified to effect a change in cache configuration. For example, if a given workload is expected to exhibit very high spatial locality characteristics, the L4 cache may be reconfigured to use fewer, but large cache blocks. In another example, if the given workload is expected to exhibit very low spatial locality, then the L4 may be reconfigured to use more, but smaller, cache blocks. A processor's workload may include memory access patterns of one or more threads of execution on the processor.

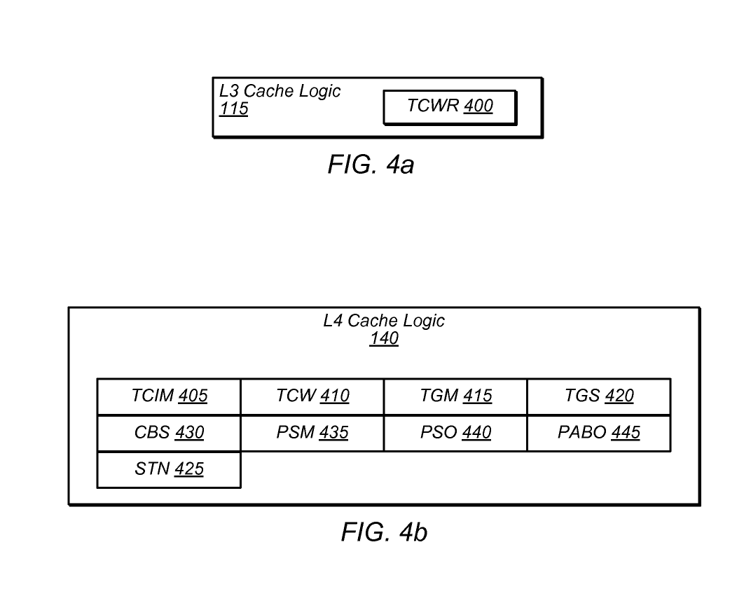

FIGS. 4a and 4b illustrate various registers that the L3 and L4 logic may include in order to implement a reconfigurable L4 cache. The registers may be of various sizes, depending on the data they are intended to hold and on the L4 and/or L3 configurations. Furthermore, in various embodiments, different ones of the registers may be combined, decomposed into multiple other registers, and/or the information stored in the registers may be otherwise distributed. L3 cache logic 115 of FIG. 4a and L4 cache logic 140 of FIG. 4b may correspond to cache logics 115 and 140 of FIG. 1 respectively.

According to FIG. 4a, the L3 cache logic may include a tag cache way reservation vector, such as TCWR 400. TCWR register 400 may indicate which blocks of the L3 cache are reserved for storing L4 tags. For example, TCWR 400 may store a mask vector indicating that which ways in each cache set are reserved for L4 tags. To denote that the first eight ways of each set are reserved (e.g., as in FIG. 3a), the vector may be 0xFF. Thus, the L3 cache may use the value stored in the TCWR register to determine which cache lines it may use for storing L3 data and which ones are reserved for storing L4 tags.

In FIG. 4b, L4 cache logic 140 includes a number of registers to assist in tag access (e.g., TCIM 405, TCW 410, TGM 415, TGS 420), a number of registers to assist in L4 data access (e.g., CBS 430, PSM 435, PSO 440, and PABO 445), and one or more miscellaneous registers useful for other purposes (e.g., STN 425). These registers and their use are described below.

Tag size register (TGS) 420, which may be used to indicate the number of bits per tag. For example, using the embodiment of FIG. 2, TGS register 420 may indicate that the tag size is 25 bits. In some embodiments, TGS register 420 may be used to generate a tag mask for calculating the tag of a given address.

In the illustrated embodiment, L4 cache logic 140 includes a tag mask register, TGM 415, which may be usable to get the L4 tag from a corresponding physical address. For example, the TGM may be chosen such that performing a bitwise-AND operation using the tag mask and a given physical address would yield the tag of that address. For example, to extract the highest order 25 bits from address 200 of FIG. 2, TGM register may hold the hexadecimal number 0xFFFFFF800000.

L4 logic 140 also includes tag cache ways register (TCW) 410. TCW register 410 may be used to identify which L3 blocks are configured to hold a given L4 tag. For example, if tags are stored in L3 blocks according to a stripped allocation pattern (as discussed above) the TCW register may comprise three fields: a way mask (indicating the first block in an L3 set that stores tags for a given L4 set), a number field (indicating the number of L3 blocks storing tag data for the L4 set), and a stride field (indicating the number of L4 sets for which the L3 set stores tag data). These fields and their use are described in more detail below.

The way mask field may be usable to identify the first block (within a given L3 set) that holds tag data for a given L4 set. To illustrate, consider the example of FIG. 3a, where each L3 set (e.g., set 300) stores tag data for four L4 sets in a stripped allocation pattern. Two bits may be used to determine which of the first four blocks stores tags for a given set. In such an example, the way mask field may be configured such that masking the physical address using the way mask (i.e., performing a logical-AND operation on the two) would yield an identifier of the L3 block that stores the L4 tags corresponding to the L4 set to which the physical address maps. For example, the TCW 410 may hold the hexadecimal value 0x300, which, when used to mask a physical address such as 200, would yield the eighth and ninth bits of the physical address. Those two bits may be used to determine a number between 0-3, which is usable to identify which of the first four reserved blocks (i.e., 310 of L3 cache set 300) hold the tags for the L4 set to which the physical address maps. For example, if the two bits were 00, then the value may identify the first block in 310, a value of 01 may identify the second block, and so forth.

The number field of the TCW register may indicate the number of blocks to be read in order to obtain all the tags corresponding to an L4 set. For example, since L3 cache set 300 uses two L3 blocks to store the tags corresponding to any given L4 set, the number field may be two.

The stride field of the TCW register may indicate the number of L4 sets for which the L3 set stores tag data. For example, since L3 cache set 300 stores tag data for four L4 sets (i.e., sets 0-3 in FIG. 3a), the stride field may be four.

If L4 tags are stored in a given L3 cache set according to a striped allocation pattern, the combination of way mask, number, and stride fields may be usable to locate all tags in an L3 set that correspond to a given L4 set. For example, in order to get the L4 tag data associated with a given L4 set, one or more of cache logics 110 and/or 135 may use the way mask to identify the first relevant block in the L3 set. The logic may then use the stride and number fields to determine the striping pattern used and therefore, to locate and read all other blocks in the L3 set that store tag data for the L4 set. For example, a stride value of 4 and number field value of 2 would indicate that there is one additional block to read after the first block, and that the additional block is the fourth block from the first (i.e., the fifth block, as in FIG. 3a). Therefore, in such an embodiment, the Nth block to read may be calculated as (the physical address & wayMaskField+strideField*(N−1). To read all relevant blocks, the logic may repeat this calculation for each N from zero to the value of the number field.

According to the illustrated embodiment, cache logic 140 also includes tag cache index mask (TCIM) 405. TCIM 405 may be used to indicate the specific L3 set that stores tags for a given L4 set. For example, the TCIM value may be used to calculate an L3 index as (PhysicalAddress &>TCIM), where “&>” denotes a logical AND operation followed by a right shift to drop the trailing zeros. For instance, if, as in the running example, the L3 has 8192 sets (16 MB/(64 B blocks*32-block sets), then the L3 set index may be calculated as bits 22-10 of the physical address. Therefore, TCIM 405 may hold the value 0x7FFC00.

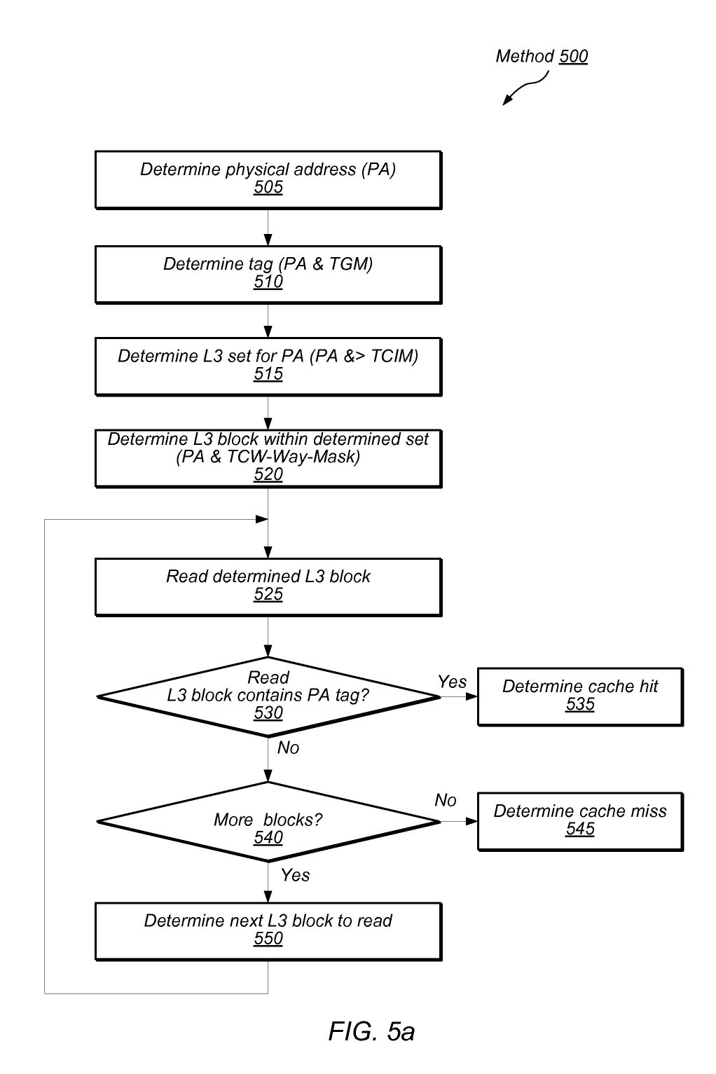

FIG. 5 is a flow diagram illustrating a method for consulting L4 tags stored in an L3 cache to determine whether the L4 cache stores data corresponding to a given memory address, according to some embodiments. Method 500 may be performed by L4 cache logic 135 and/or by L3 cache logic 115. The respective cache logics may be configured as shown in FIGS. 4a and 4b, including respective registers as described above.

According to the illustrated embodiment, the method begins when the logic determines a physical address (PA), as in 505. For example, the logic may determine that a program instruction is attempting to access the given physical address and, in response, the logic may need to determine whether data corresponding to that address is stored in the L4 cache.

In 510, the logic determines a tag for the physical address. For example, in some embodiments, the logic may determine a tag by masking the physical address using a tag mask, such as that stored in TGM 415 (e.g., PA & TGM).

In 515, the logic may determine the L3 set in which data corresponding to the physical address would be stored. For example, the logic may identify the particular L3 set by performing a “&>” operation on the physical address using the TCIM, as described above.

Once the logic has identified the tag for which to search (as in 510) and the L3 set in which to search for that tag (as in 515), the logic may determine a first block to search within the determined L3 set (as in 520). For example, in some embodiments, the logic may determine which block within the set to search by masking the physical address with the way mask field of the TCW register (i.e., PA & TCW-way-mask), as indicated in 520.

According to the illustrated embodiment, once the logic determines the first L3 cache block to inspect, it may read the L3 block (as in 525) and determine (as in 530) whether the L3 block contains the PA tag that was determined in 510. If the block does contain the PA tag, as indicated by the affirmative exit from 530, then the cache logic may determine a cache hit, as in 535. Otherwise, as indicated by the affirmative exit from 530, the logic cannot determine a cache hit. Instead, the logic may inspect zero or more other L3 blocks that may store the PA tag to determine if any of those blocks store the tag.

In 540, the cache logic determines whether more tags exist. For example, if the number field of the TCW register holds a value greater than the number of blocks already searched, then there are more blocks to search. Otherwise, the logic has searched every L3 block that could potentially hold the tag.

If the logic has already searched every L3 block that could hold the tag, as indicated by the affirmative exit from 540, then the logic may conclude that there is a cache miss, as in 545. Otherwise, if there are more L3 blocks to search (e.g., number field is greater than blocks already searched), then the logic may determine the next block to search, as in 550. For example, in some embodiments, the logic may make such a determination based on the identity of the previously read register and the stride field of the TCW register. Once the logic has determined the next L3 cache block to search (as in 550), it may search that L3 cache block, as indicated by the affirmative feedback loop from 550 to 525.

If the cache logic locates the tag in the L3 cache, the logic may note the block in which the tag was found. For example, the logic may note the block by recording a tag offset indicating the position of the block within the set.

As discussed above, in some embodiments, the L4 may be implemented using stacked DRAM, which may be arranged as multiple DRAM pages. A single DRAM page may hold data for multiple L4 cache blocks.

In some embodiments, each DRAM page may store a group of cache blocks that correspond to a contiguous set of physical memory. By storing a contiguous set of memory in each page, the L4 cache can better exploit spatial locality in application access patterns.

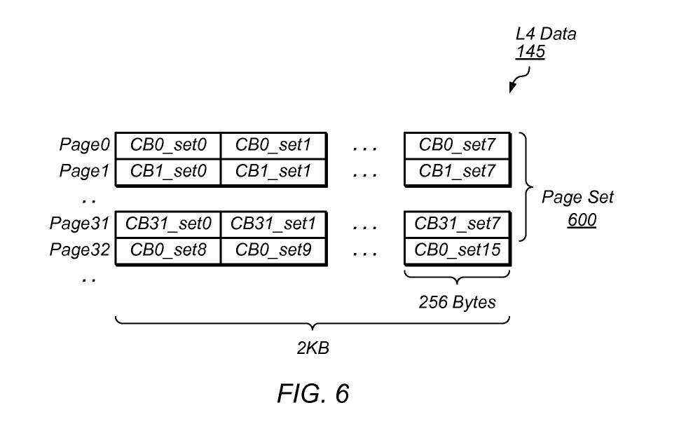

FIG. 6 illustrates an example arrangement of cache blocks on DRAM pages, wherein each page stores physically contiguous memory. According to the illustrated embodiment, L4 data 145 comprises multiple pages, such as pages 0-21. Each page has a capacity of 2 KB and can therefore store 16 256-byte cache blocks.

In FIG. 6, adjacent cache blocks are stored together on the same page. For example, the first cache block from each of the first eight sets (CB0 of sets 0-7) is stored on page0, the second cache block from each of the first eight sets (CB1 of sets 0-7) are stored on page1, and so forth. Accordingly, in this example, the first thirty-two pages of L4 data 145 cumulatively store all the cache blocks for the first eight, 32-way sets of L4 cache 135. The contiguous set of pages that store the cache blocks for a given set may be referred to as a page set, such as page set 600 of FIG. 6.

In addition to the tag-related registers described above, the L4 cache logic may include a number of registers usable to facilitate access to L4 data (e.g., L4 data 145). For example, returning to FIG. 4a, such registers may include a cache block size register (e.g., CBS 430), a page set mask (e.g., PSM 435), a page set offset (e.g., PSO 440), and a page access base offset (e.g., PABO 445).

In some embodiments, CBS register 430 may store a value indicating the size of each cache block. For example, CBS register 430 may store the value 256 to indicate that each L4 cache block (i.e., cache line) comprises 256 bytes.

PSM register 435 may store a mask usable to determine the page set to which a given physical address maps. For example, if each DRAM page holds eight cache blocks (as in FIG. 6), then bits 11-22 of the physical address may be used to identify the DRAM page set. To extract those bits from a physical address (e.g., from physical address 200), the cache logic may store the hexadecimal value 0x7FF800 in the PSM register and use that value to mask the physical address.

Once the cache logic determines the page set to which a physical address maps (e.g., by masking the address using PSM register 435), the cache logic may use PSO register 440 to determine the specific DRAM page in the determined page set to which the physical address maps. Because the maximum offset is the L4 associativity (e.g., 32), the cache logic may shift the page set value by log₂(L4_associativity) and then add the tag offset (which may have been calculated during the tag access phase described above). For example, for a 32-way L4 cache, the PSO value may be 5 (i.e., log₂(32)).

Once the cache logic determines the DRAM page to which the physical address maps (e.g., as described above), the cache logic may use PABO register 445 to identify the specific cache block within the determined page to which the physical address maps. The logic may derive an offset into the DRAM page by masking the physical address using the value in the PABO register. For example, if each DRAM page holds eight cache blocks (as in FIG. 6), a PABO value of 0x700 may be used to determine an index into the page by masking all but bits 8-10 of the physical address.

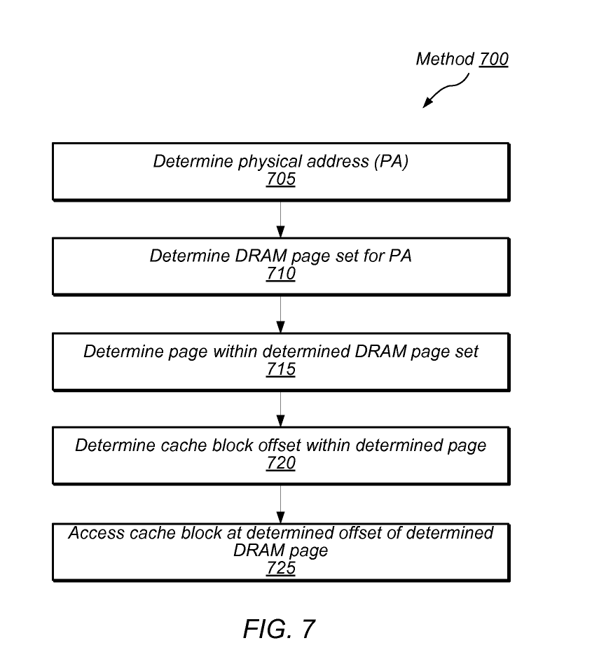

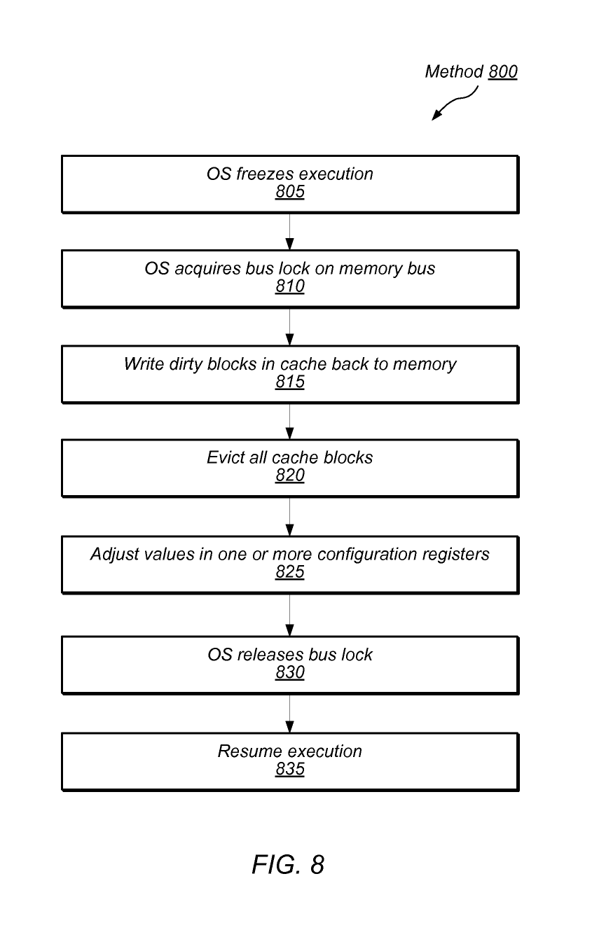

FIG. 7 is a flow diagram illustrating a method for locating the L4 cache block that corresponds to a given physical address, according to some embodiments. The method of FIG. 7 may be executed by L4 cache logic, such as 145 of FIG. 1.

Method 700 begins when the cache logic determines a physical address in 705. The cache logic may determine the physical address in response to a program instruction requiring access (e.g., read/write) to the given physical address.

In 710, the L4 cache logic determines the DRAM page set that maps to the physical address. Determining the DRAM page may comprise masking the physical address using a page set mask, such as PSM register 435. In 715, the cache logic determines the particular page to which the physical address maps within the determined set. Determining the particular page within the set may comprise left shifting the page set calculated in 710 by the value in PSO register 440 and adding the tag offset, which may have been calculated during the tag access phase. In 720, the cache logic determines an offset at which the desired block is stored within the determined page. Determining the offset may comprise performing a “&>” (logical AND, followed by right shift to drop trailing zeros) using the value in PABO register 445. To generalize, in some embodiments, the DRAM page to which a physical address PA maps may be given by [(PA & PSM)<<PSO]+tagOffset, and the cache block offset into the page may be given by PA &>PABO. Once the cache logic determines the page and offset (as in 710-720), it may access the cache block at the determined offset of the determined DRAM page (as in 725).

As described above, traditional caches are statically configured (e.g., block size, number of blocks, degree of associativity, etc.). However, no one configuration is optimal for every workload.

In various embodiments, the L4 cache may be dynamically reconfigurable to provide optimal performance for current or expected workload. A cache that is dynamically reconfigurable at runtime may be reconfigured by software (e.g., OS) without requiring a system restart and/or manual intervention. For example, the system BIOS may be configured to start the cache in a default configuration by setting default values in configuration registers 400-445. During runtime, the operating system may monitor workload characteristics to determine the effectiveness of the current cache configuration. If the operating system determines that a different cache configuration would be beneficial, the OS may reconfigure the L4 (and/or L3) cache, as described below.

FIG. 8 is a flow diagram of a method for reconfiguring an L4 cache during runtime, according to some embodiments. Method 800 may be performed by an operating system executing one or more threads of execution on the processor.

Method 800 begins with step 805, wherein the OS freezes execution of all system threads. In 810, the OS then acquires a lock on the memory bus, such that no program instructions or other processing cores may access the bus. In 815, the OS writes all dirty cache blocks back to memory. A cache block is considered dirty if the processor has modified its value but has not yet written that value back to memory. In 820, the OS evicts all data from the cache. In 825, the OS adjusts one or more values in the configuration registers to reflect the new cache configuration. The OS then releases the bus lock (in 830) and resumes execution (in 835).

Using method 800, the operating system can modify various configuration parameters of the L4 cache to reflect the current or expected workload. Such parameters may include block size, number of blocks, associativity, segmentation, or other parameters. For example, if the OS determines that the application is exhibiting access patterns with high spatial locality, the OS may increase the L4 cache block size by modifying some number of the configuration registers 400-445, which may increase performance for the highly spatial application by prefetching more data into L4. Increasing L4 block size may also increase the size of the L3 because the L4 requires a smaller amount of tag storage space, which the L3 can reclaim and use for storing L3 data. by increasing the size of the improving performance for access patterns with high spatial locality. In another example, the OS may modify the L4 cache's level of associativity. If it does not cause a significant increase in conflict misses, decreasing the L4 cache's level of associativity may lead to lower access latency as well as cache power savings. Conversely, higher associativity reduces conflict misses, which may result in a performance boost in some workloads.

In another example of reconfigurability, the OS may reconfigure the L4 as a sectored cache. As shown in FIG. 4b, L4 cache logic 140 may include a sector number register (e.g., STN 425) that stores a sector number that indicates the number of bits required to identify the validity of different sectors in a given cache block. If the L4 cache is not sectored, then the sector number may be set to 0. However, the OS may reconfigure the L4 cache to include multiple sectors by modifying the STN register with a different value.

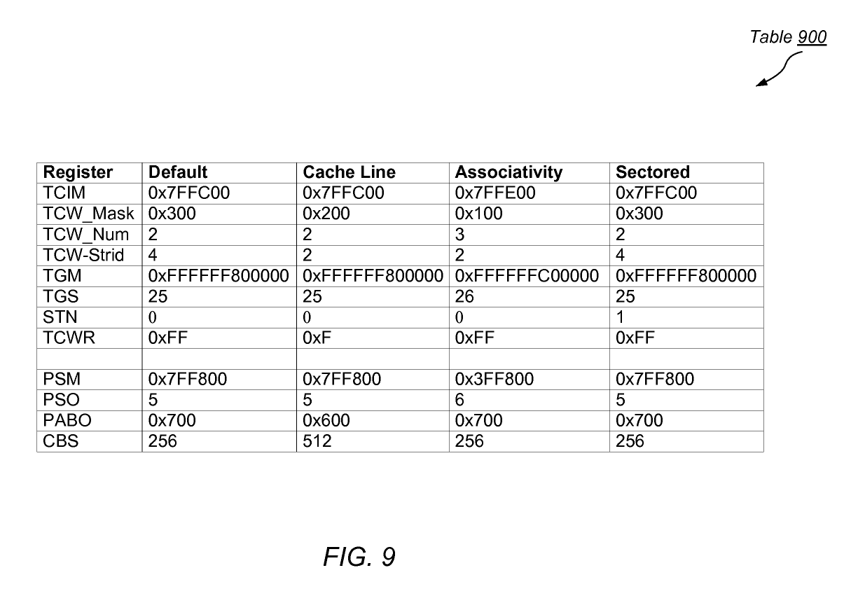

In some embodiments, the OS may be configured to reconfigure the L4 cache according to various preset configurations. For example, table 900 of FIG. 9 gives four example configurations for the configuration registers. Each configuration targets respective workload characteristics. For example, table 900 includes a default configuration (e.g., a configuration in which the BIOS starts the cache), a large cache line configuration (i.e., 512 B cache blocks), a high associativity configuration (i.e., 64-way set associative), and a sectored cache design (i.e., two sectors). In various embodiments, the processor may use these default configurations, other default configurations, and/or custom configurations depending on the observed workload.

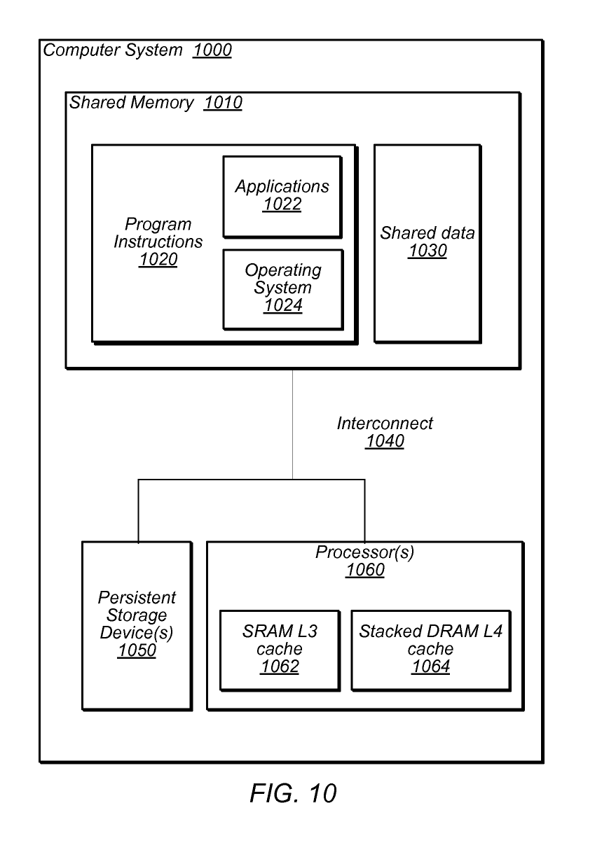

FIG. 10 is a block diagram illustrating a computer system configured to utilize a stacked DRAM cache as described herein, according to some embodiments. The computer system 1000 may correspond to any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc, or in general any type of computing device.

Computer system 1000 may include one or more processors 1060, any of which may include multiple physical and/or logical cores. Any of processors 1060 may correspond to processor 100 of FIG. 1 and may include data caches, such as SRAM L3 cache 1062 and stacked DRAM L4 cache 1064, as described herein. Caches 1062 and 1064 may correspond to L3 cache 110 and L4 cache 135 of FIG. 1 respectively. Thus, L4 cache 1064 may be reconfigurable by OS 1024, as described herein. Computer system 1000 may also include one or more persistent storage devices 1050 (e.g. optical storage, magnetic storage, hard drive, tape drive, solid state memory, etc), which may persistently store data.

According to the illustrated embodiment, computer system 1000 includes one or more shared memories 1010 (e.g., one or more of cache, SRAM, DRAM, RDRAM, EDO RAM, DDR 10 RAM, SDRAM, Rambus RAM, EEPROM, etc.), which may be shared between multiple processing cores, such as on one or more of processors 1060. The one or more processors 1060, the storage device(s) 1050, and shared memory 1010 may be coupled via interconnect 1040. In various embodiments, the system may include fewer or additional components not illustrated in FIG. 10 (e.g., video cards, audio cards, additional network interfaces, peripheral devices, a network interface such as an ATM interface, an Ethernet interface, a Frame Relay interface, monitors, keyboards, speakers, etc.). Additionally, different components illustrated in FIG. 10 may be combined or separated further into additional components.

In some embodiments, shared memory 1010 may store program instructions 1020, which may be encoded in platform native binary, any interpreted language such as Java™ byte-code, or in any other language such as C/C++, Java™, etc or in any combination thereof. Program instructions 1020 may include program instructions to implement one or more applications 1022, any of which may be multi-threaded. In some embodiments, program instructions 1020 may also include instructions executable to implement an operating system 1024, which may be configured to monitor workloads on processor(s) 1060 and to reconfigure caches 1064 and 1062, as described herein. OS 1024 may also provide other software support, such as scheduling, software signal handling, etc.

According to the illustrated embodiment, shared memory 1010 includes shared data 1030, which may be accessed by ones of processors 1060 and/or various processing cores thereof. Ones of processors 1060 may cache various components of shared data 1030 in local caches (e.g., 1062 and/or 1064) and coordinate the data in these caches by exchanging messages according to a cache coherence protocol. In some embodiments, multiple ones of processors 1060 and/or multiple processing cores of processors 1060 may share access to caches 1062, 1064, and or off-chip caches that may exist in shared memory 1010.

Program instructions 1020, such as those used to implement applications 1022 and/or operating system 1024, may be stored on a computer-readable storage medium. A computer-readable storage medium may include any mechanism for storing information in a form (e.g., software, processing application) readable by a machine (e.g., a computer). The computer-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions.

A computer-readable storage medium as described above may be used in some embodiments to store instructions read by a program and used, directly or indirectly, to fabricate hardware comprising one or more of processors 1060. For example, the instructions may describe one or more data structures describing a behavioral-level or register-transfer level (RTL) description of the hardware functionality in a high level design language (HDL) such as Verilog or VHDL. The description may be read by a synthesis tool, which may synthesize the description to produce a netlist. The netlist may comprise a set of gates (e.g., defined in a synthesis library), which represent the functionality of processor 500. The netlist may then be placed and routed to produce a data set describing geometric shapes to be applied to masks. The masks may then be used in various semiconductor fabrication steps to produce a semiconductor circuit or circuits corresponding to processors 100 and/or 1060. Alternatively, the database may be the netlist (with or without the synthesis library) or the data set, as desired.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus comprising:
a first data cache;
a second data cache; and
cache logic configured to cache memory data in the first data cache by:
storing the memory data in the first data cache; and
storing in the second data cache, but not in the first data cache, tag data corresponding to the memory data.

2. The apparatus of claim 1, wherein the first and second data caches implement respective levels of a data cache hierarchy of a processor.

3. The apparatus of claim 2, wherein the level implemented by the first data cache is immediately below the level implemented by the second data cache in the cache hierarchy.

4. The apparatus of claim 1, wherein the first data cache is implemented on the processor using stacked memory.

5. The apparatus of claim 4, wherein:
the stacked memory is organized as a plurality of memory pages, wherein the cache logic is configured to store in each memory page, memory data corresponding to a contiguous region of a physical system memory.

6. The apparatus of claim 1, wherein the first data cache is dynamically reconfigurable at runtime.

7. The apparatus of claim 6, wherein the first data cache is dynamically reconfigurable at runtime to modify a size, a block size, a number of blocks, or an associativity level of the first data cache.

8. The apparatus of claim 6, wherein the first data cache is dynamically reconfigurable at runtime by an operating system in response to a determination made by the operating system, wherein the determination depends on one or more characteristics of a workload of the processor.

9. The apparatus of claim 6, wherein reconfiguring the first data cache comprises modifying one or more configuration registers of the first data cache, wherein the configuration registers are usable to determine a block of the second data cache that stores tag information corresponding to a given block of the first data cache.

10. The apparatus of claim 6, wherein the reconfiguring comprises, an operating system performing:
freezing execution of one or more threads executing on the processor;
acquiring a lock on a memory bus connecting the processor to a system memory;
writing dirty blocks back to memory;
invalidating data in the first data cache;
releasing the lock on the memory bus; and
resuming execution of the one or more threads.

11. A method comprising:
a processor caching memory data accessed by the processor in a first data cache;
the processor storing in a second data cache, but not in the first data cache, tag information for the accessed memory data.

12. The method of claim 11, wherein the first and second data caches implement respective levels of a data cache hierarchy of the processor, wherein the level implemented by the first data cache is immediately below the level implemented by the second data cache.

13. The method of claim 11, wherein the first data cache is implemented on the processor using stacked memory.

14. The method of claim 13, wherein:
the stacked memory is organized as a plurality of memory pages, wherein the cache logic is configured to store in each memory page, memory data corresponding to a contiguous region of a physical system memory.

15. The method of claim 11, wherein the first data cache is dynamically reconfigurable at runtime.

16. The method of claim 15, wherein the first data cache is dynamically reconfigurable at runtime to modify a size, a block size, a number of blocks, or an associativity level of the first data cache.

17. The method of claim 15, wherein the first data cache is dynamically reconfigurable at runtime by an operating system in response to a determination made by the operating system, wherein the determination depends on one or more characteristics of a workload of the processor.

18. The method of claim 15, wherein reconfiguring the first data cache comprises modifying one or more configuration registers of the first data cache, wherein the configuration registers are usable to determine a block of the second data cache that stores tag information corresponding to a given block of the first data cache.

19. The method of claim 11, further comprising determining that the memory data is stored in the first data cache by:
using a physical memory address of the data to determine a tag value for the physical memory address; and
determining that the tag value is stored by the second data cache.

20. The method of claim 19, wherein determining that the tag value is stored by the second data cache comprises:
determining a cache block of the second data cache, the cache block corresponding to the physical memory address, wherein the determining is dependent on one or more cache configuration values stored in one or more configuration registers of the second data cache; and
determining that the cache block stores the tag value.

21. A computer readable storage medium comprising a data structure which is operated upon by a program executable on a computer system, the program operating on the data structure to perform a portion of a process to fabricate an integrated circuit including circuitry described by the data structure, the circuitry described in the data structure including:
a first data cache;
a second data cache;
wherein the apparatus is configured to store cache memory data in the first data cache, and wherein tag information usable to access the cache memory data stored in the first data cache is stored in the second data cache but not in the first data cache.

22. The computer readable storage medium of 21, wherein the storage medium stores HDL, Verilog, or GDSII data.

23. A method comprising:
caching memory data in a first cache by storing the memory data in a data array of the first cache and storing corresponding tag data for the first cache in a data array of a second data cache and not in a tag array of the first data cache.
